(19) United States
(12) Patent Application Publication
(10) Pub. No.: US 2018/0011479 A1
(43) Pub. Date: Jan. 11, 2018

(54) ERROR DIAGNOSIS METHOD AND ERROR DIAGNOSIS SYSTEM

(71) Applicant: MITSUBISHI HEAVY INDUSTRIES, LTD., Tokyo (JP)

(72) Inventor: Tetsuya NAGASE, Tokyo (JP)

(73) Assignee: MITSUBISHI HEAVY INDUSTRIES, LTD., Tokyo (JP)

(21) Appl. No.: 15/545,423

(22) PCT Filed: Jan. 25, 2016
(86) PCT No.: PCT/JP2016/052009

§ 371 Date: Jul. 21, 2017

(30) Foreign Application Priority Data
Jan. 27, 2015 (JP) 2015-013754

(51) Int. Cl. G05B 19/418; G05B 23/02

(52) U.S. Cl. CPC G05B 19/4184; G05B 23/0259; G05B 2219/37581; G05B 2219/37506

(57) ABSTRACT

An error diagnosis method includes: the parameter value obtaining step of obtaining multiple parameter values; the error detection step of calculating a Mahalanobis distance from a unit space based on the obtained parameter values and diagnosing whether or not error is caused at the real machine based on the calculated Mahalanobis distance; the error portion estimation step of estimating a error portion of the real machine based on the Mahalanobis distance calculated at the error detection step; and the matching determination step of structuring an error analyzing model for analyzing the real machine based on the error portion of the real machine estimated at the error portion estimation step and determining whether or not an output analytical signal of the real machine obtained by analysis of the error analyzing model and the output signal output from the real machine match with each other.

### FIELD

The present invention relates to an error diagnosis method and an error diagnosis system.

### BACKGROUND

Typically, an anormaly diagnosis device (see, e.g., Patent Literature 1) configured to diagnose an anormaly of a plant and a plant operation state monitoring method (see, e.g., Patent Literature 2) for determining whether or not a plant is in normal operation have been known. In the inventions described in Patent Literatures 1 and 2, a Mahalanobis distance is obtained, and the presence or absence of the anormaly is diagnosed by comparing between the obtained Mahalanobis distance and a preset threshold.

### CITATION LIST

### Patent Literature

Patent Literature 1: Japanese Laid-open Patent Publication No. 2014-35282

Patent Literature 2: Japanese Laid-open Patent Publication No. 2013-101718

### SUMMARY

### Technical Problem

Error diagnosis for diagnosing error such as an anormaly or failure may include not only error detection for detecting whether or not error is caused at a target machine targeted for diagnosis, but also identification of an error portion of the target machine. Generally in error detection and error portion identification, an error analyzing model is structured based on the estimated error portion of the target machine. Then, it is determined whether or not an output analytical signal as an output signal of the target machine obtained by analysis of the error analyzing model and an actual output signal as the output signal of the target machine match with each other. When the output analytical signal and the actual output signal match with each other, it is assumed that error is caused at the estimated error portion, and therefore, error detection and error portion identification are simultaneously performed. On the other hand, when the output analytical signal and the actual output signal do not match with each other, it is assumed that no error is caused at the estimated error portion. Thus, the error analyzing model is structured again based on another error portion, and such processing is repeated until the output analytical signal and the actual output signal match with each other.

However, in the case of simultaneously performing error detection and error portion identification, it takes time until detection of error. Particularly in the case of controlling the target machine based on error detection, such error detection needs to be promptly performed. Specifically, when, e.g., a rocket is applied as a machine used for the space field and attitude control of the rocket is performed, error needs to be promptly detected.

Thus, the present invention is intended to provide an error diagnosis method and an error diagnosis system configured so that error can be promptly detected.

### Solution to Problem

An error diagnosis method of this invention comprises: a parameter value obtaining step of obtaining parameter values of multiple parameters contained in at least one of an input signal to be input to a target machine targeted for error diagnosis or an output signal output from the target machine; an error detection step of detecting, using a multidimensional statistical technique, whether or not error is caused at the target machine based on the parameter values obtained at the parameter value obtaining step; and an error portion estimation step of estimating an error portion of the target machine based on characteristic data obtained at the error detection step.

In an error diagnosis system of this invention, parameter values of multiple parameters contained in at least one of an input signal to be input to a target machine targeted for error diagnosis or an output signal output from the target machine are obtained, based on the obtained parameter values, it is, using a multidimensional statistical technique, detected whether or not error is caused at the target machine, and an error portion of the target machine is estimated based on characteristic data obtained by the multidimensional statistical technique.

According to such a configuration, the error portion of the target machine can be estimated after detection of error of the target machine. Thus, error can be detected in advance without simultaneously performing error detection and error portion identification, and therefore error can be promptly detected. Note that error of the target machine is not limited to a failure state of the target machine, and may include an abnormal state before failure of the target machine.

It is preferable to further comprises a matching determination step of structuring an error analyzing model for analyzing the target machine based on the error portion of the target machine estimated at the error portion estimation step, thereby determining whether or not an output analytical signal of the target machine obtained by analysis of the error analyzing model and the output signal output from the target machine match with each other.

It is preferable that an error analyzing model for analyzing the target machine is structured based on the estimated error portion of the target machine, and it is determined whether or not an output analytical signal of the target machine obtained by analysis of the error analyzing model and the output signal output from the target machine match with each other.

According to such a configuration, the match between the output analytical signal based on the estimated error portion and the actual output signal of the target machine is determined so that the error portion of the target machine can be identified.

It is preferable that the multidimensional statistical technique is a Mahalanobis Taguchi method, at the error detection step, a Mahalanobis distance from a preset unit space is calculated using the Mahalanobis Taguchi method, and it is detected whether or not the error is caused at the target machine based on the calculated Mahalanobis distance, and at the error portion estimation step, the error portion of the target machine is estimated based on the Mahalanobis distance as the characteristic data.

It is preferable that the multidimensional statistical technique is a Mahalanobis Taguchi method, a Mahalanobis distance from a preset unit space is calculated using the Mahalanobis Taguchi method, and it is detected whether or not the error is caused at the target machine based on the calculated Mahalanobis distance, and the error portion of the target machine is estimated based on the Mahalanobis distance calculated as the characteristic data by the Mahalanobis Taguchi method.

According to such a configuration, the Mahalanobis Taguchi method can be used at the error portion estimation step, and therefore, error can be detected with a high reliability. Moreover, the Mahalanobis distance calculated at the error portion estimation step can be used at the error portion estimation step, and therefore, the error portion can be accurately estimated.

It is preferable that the error portion estimation step includes: an item diagnosis step of selecting, using the Mahalanobis Taguchi method, the parameters having influence on the Mahalanobis distance calculated at the error detection step; and a machine error estimation step of estimating, using a Bayesian network, the error portion of the target machine based on the parameters selected at the item diagnosis step.

According to such a configuration, the optimal parameter having influence on error of the target machine can be, by the item diagnosis step, selected using the Mahalanobis distance calculated at the error detection step. Further, the Bayesian network is used at the machine error estimation step so that the error portion of the target machine can be accurately estimated from the selected parameter.

It is preferable that at the error portion estimation step, the item diagnosis step is performed when it is determined that no error is caused at the target machine in the error detection step, and the error portion estimation step further includes a parameter storage step of storing the parameters selected at the item diagnosis step.

According to such a configuration, even when it is determined that no error is caused at the target machine, the item diagnosis step is performed using the Mahalanobis distance calculated at the error detection step, and in this manner, the parameter being likely to have influence on error of the target machine can be selected in advance, and can be stored.

It is preferable that in the error portion estimation step, the machine error estimation step is performed based on the parameters stored at the parameter storage step, when it is determined that the error is caused at the target machine in the error detection step.

According to such a configuration, the parameter selected in advance and being likely to have influence on error of the target machine is used preferentially so that the error portion of the target machine can be estimated. Thus, the item diagnosis step can be skipped, and accordingly, the error portion can be promptly estimated.

### BRIEF DESCRIPTION OF DRAWINGS

FIG. 1 is a schematic diagram of an error diagnosis system of the present embodiment.

FIG. 2 is a diagram for describing operation of the error diagnosis system of the present embodiment.

FIG. 3 is a graph for describing a unit space and a Mahalanobis distance.

FIG. 4 is a graph for describing a graph of factorial effects.

### DESCRIPTION OF EMBODIMENTS

An embodiment of the present invention will be described below in detail with reference to the drawings. Note that the present invention is not limited to this embodiment. Moreover, components in the embodiment described below include components easily replaceable by those skilled in the art, or the substantially same components. Further, the components described below can be optionally combined together. In addition, when there are multiple embodiments, these embodiments can be combined together.

### Embodiment

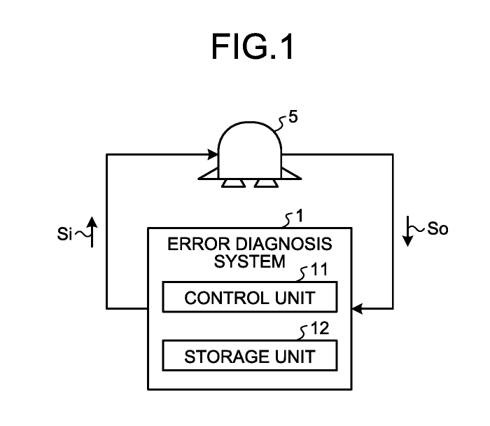

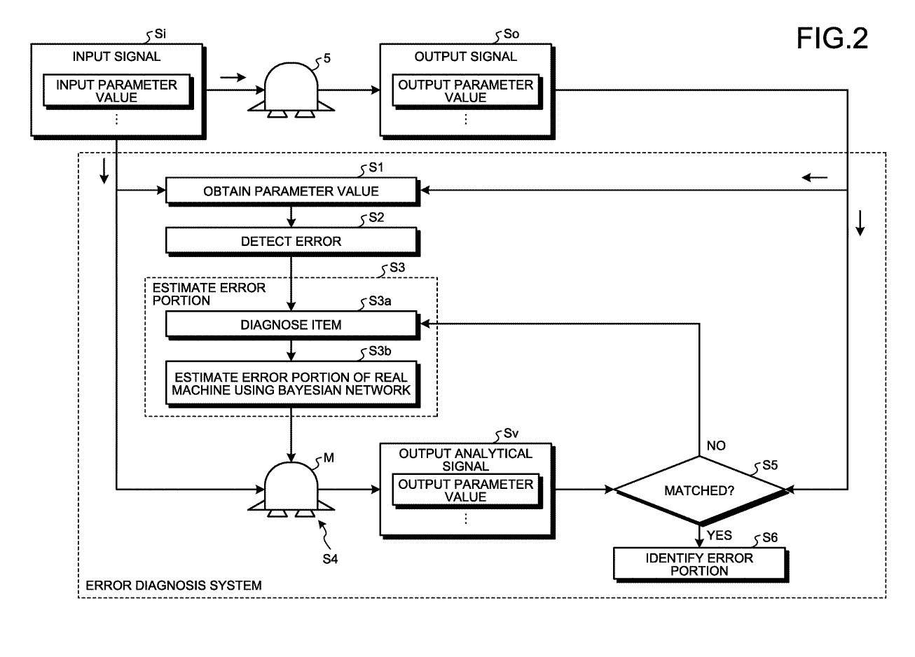

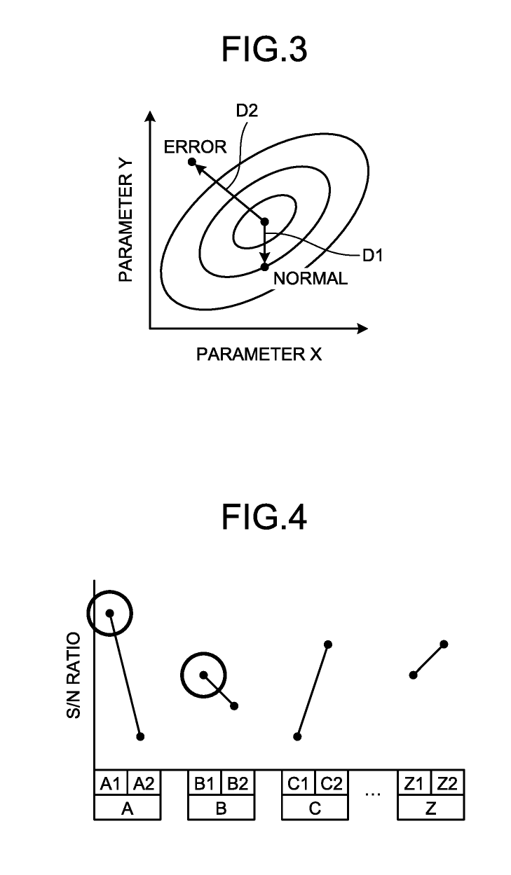

FIG. 1 is a schematic diagram of an error diagnosis system of the present embodiment. FIG. 2 is a diagram for describing operation of the error diagnosis system of the present embodiment. FIG. 3 is a graph for describing a unit space and a Mahalanobis distance. FIG. 4 is a graph for describing a graph of factorial effects.

As illustrated in FIG. 1, in an error diagnosis system 1, a real machine 5 such as an airplane or a flying object is applied as a target machine targeted for error diagnosis. Note that in the present embodiment, the real machine 5 will be simply described, but the real machine 5 is not limited, and may be applied to an industrial machine, a plant, and the like. The error diagnosis system 1 is particularly useful for the real machine 5 configured to perform control based on error detection. Moreover, error of the real machine 5 is not limited to a failure state of the real machine 5, and includes an abnormal state before failure of the real machine 5.

The error diagnosis system 1 includes a control unit 11 and a storage unit 12. The error diagnosis system 1 is configured to output an input signal Si to be input to the real machine 5 and to receive an output signal So output from the real machine 5. The storage unit 12 is configured to store, for example, various programs for error diagnosis and parameter values of various parameters contained in the input signal Si and the output signal So used for error diagnosis. Although will be described below in detail, the control unit 11 is configured to detect error of the real machine 5 and identify an error portion of the real machine 5 based on the input signal Si, the output signal So, and the like.

Next, the error diagnosis system 1 will be specifically described with reference to FIG. 2. In error diagnosis of the real machine 5, the error diagnosis system 1 executes various programs stored for error diagnosis in the storage unit 12, thereby performing a parameter value obtaining step S1, an error detection step S2, an error portion estimation step S3, an error analyzing step S4, a matching determination step S5, and an error portion identification step S6.

At the parameter value obtaining step S1, the error diagnosis system 1 obtains the input signal Si to be input to the real machine 5 and the output signal So output from the real machine 5. The input signal Si contains input parameter values of multiple input parameters used for control of the real machine 5, and the input parameters include, for example, information on environment around the real machine 5 or an operation command of the real machine 5. The output signal So contains output parameter values of multiple output parameters obtained from a measurement sensor configured to measure each portion of the real machine 5, and the output parameters include, for example, a pressure value, a temperature, a voltage value, and a current value at a predetermined portion, the output value of the real machine 5, the position of the real machine 5, the attitude of the real machine 5, and the velocity of the real machine 5. The error diagnosis system 1 stores, in the storage unit 12, the parameter values of the multiple parameters obtained at the parameter value obtaining step S1.

Note that at the parameter value obtaining step S1 of the present embodiment, the parameter values for the input signal Si and the output signal So are obtained, but the parameter values contained in at least one of the input signal Si or the output signal So may be obtained. There are no particular limitations as long as the multiple parameter values are obtained.

At the error detection step S2, a Mahalanobis distance D from a preset unit space F is calculated by using a Mahalanobis Taguchi method (a so-called MT method), based on the multiple parameter values obtained at the parameter value obtaining step S1. Based on the calculated Mahalanobis distance D, it is detected whether or not error is caused at the real machine 5. At this point, the storage unit 12 of the error diagnosis system 1 stores a multidimensional space illustrated in FIG. 3 based on the multiple parameters (e.g., a parameter X and a parameter Y). The unit space F as normal is set in advance within the multidimensional space. The unit space F is set based on multiple data points at which a correlation among the multiple parameter values is regarded as normal. Note that in the unit space F, multiple spaces expanding outward from the center may be formed.

The Mahalanobis distance D is a distance from the center of the unit space F, and is calculated using a predetermined calculation formula for calculating the Mahalanobis distance D. That is, the control unit 11 calculates the Mahalanobis distance D by substituting the multiple parameter values obtained at the parameter value obtaining step S1 into the predetermined calculation formula.

When the Mahalanobis distance D calculated by the control unit 11 is a Mahalanobis distance D1 on the inside of the unit space F as illustrated in FIG. 3, the control unit 11 detects, at the error detection step S2, that no error is caused at the real machine 5. On the other hand, when the Mahalanobis distance D calculated by the control unit 11 is a Mahalanobis distance D2 departing outward from the unit space F, the control unit 11 detects, at the error detection step S2, that error is caused at the real machine 5. Note that when the control unit 11 detects, at the error detection step S2, that no error is caused at the real machine 5, the control unit 11 repeatedly executes the error detection step S2 until detection of occurrence of error.

At the error portion estimation step S3, an error portion of the real machine 5 is estimated based on the Mahalanobis distance D calculated at the error detection step S2. Note that the estimated error portion may be one or more portions and is not limited. Specifically, the error portion estimation step S3 includes an item diagnosis step S3a and a real machine error estimation step (a machine error estimation step) S3b.

At the item diagnosis step S3a, a parameter having influence on the Mahalanobis distance D calculated at the error detection step S2 is selected using the Mahalanobis Taguchi method. Specifically, at the item diagnosis step S3a, allocation to a not-shown orthogonal table is, using the Mahalanobis Taguchi method, performed for the multiple parameters used for calculation of the Mahalanobis distance D. In the orthogonal table, different parameter values are allocated to each parameter. For example, parameter values A1 to Z1 and parameter values A2 to Z2 are allocated to predetermined parameters A to Z. Then, at the item diagnosis step S3a, a graph of factorial effects regarding an S/N ratio for each parameter as illustrated in FIG. 4 is generated based on the parameter values of the multiple parameters allocated to the orthogonal table.

FIG. 4 is the graph of factorial effects regarding the S/N ratio for each parameter, where the vertical axis represents the S/N ratio and the horizontal axis represents each parameter and the parameter values thereof. Note that the S/N ratio is generally defined as “SN RATIO=OUTPUT MAGNITUDE/DEVIATION FLUCTUATION,” and indicates the magnitude of variation. That is, a greater S/N ratio results in smaller variation, and the S/N ratio has great influence on the Mahalanobis distance D in the present embodiment. From the graph of factorial effects based on the S/N ratio, the parameter having influence on the Mahalanobis distance D is selected. For example, the parameter for which the S/N ratio is greater than a preset threshold is selected, or the predetermined number of parameters is selected in the descending order of the S/N ratio.

At the real machine error estimation step S3b, the error portion of the real machine 5 is, using a Bayesian network, estimated based on the parameter selected at the item diagnosis step S3a. The Bayesian network is structured based on a so-called Bayes' theorem, and sets the probability of greatly influencing the parameter values of each parameter when an error event at a predetermined portion of the real machine 5 is caused. That is, in the Bayesian network, the error portion and the probability of influencing each parameter are associated with each other. Thus, at the real machine error estimation step S3b, the Bayesian network is used so that the error portion of the real machine 5 associated with the parameter selected at the item diagnosis step S3a can be estimated based on the probability. That is, at the real machine error estimation step S3b, the probability of occurrence of error at the predetermined portion of the real machine 5 is derived according to the parameter selected at the item diagnosis step S3a. Then, the control unit 11 estimates, as the error portion of the real machine 5, a portion with a high probability of occurrence of error derived at the real machine error estimation step S3b.

At the analyzing step S4, the control unit 11 structures an error analyzing model M for analyzing the real machine 5 based on the error portion of the real machine 5 estimated at the error portion estimation step S3. After structuring of the error analyzing model M, the control unit 11 provides the input parameter values of the input signal Si to the error analyzing model M and performs an analysis, thereby generating an output analytical signal Sv of the real machine 5 as an analysis result.

At the matching determination step S5, the control unit 11 determines whether or not the output analytical signal Sv output at the error analyzing step S4 and the output signal So actually output from the real machine 5 match with each other. Specifically, the control unit 11 determines as matched (Step S5: Yes) when a deviation between an output parameter value of each parameter contained in the output analytical signal Sv and the output parameter value of each parameter contained in the output signal So falls within a predetermined range set in advance. Then, the processing proceeds to the error portion identification step S6. On the other hand, the control unit 11 determines as not matched (Step S5: No) when the deviation between the output parameter value of each parameter contained in the output analytical signal Sv and the output parameter value of each parameter contained in the output signal So falls outside the predetermined range set in advance. Then, the processing proceeds to the error portion estimation step S3 again, and is repeated until the control unit 11 determines as matched.

At the error portion identification step S6, when it is determined that the output analytical signal Sv and the output signal So match with each other at the matching determination step S5, the error portion estimated at the error portion estimation step S3 is identified as a portion where error is caused.

As described above, according to the present embodiment, the control unit 11 can estimate the error portion of the real machine 5 at the error portion estimation step S3, after detecting error of the real machine 5 at the error detection step S2. Then, the control unit 11 can identify the error portion of the real machine 5 at the error portion identification step S6 by determining on the match between the output analytical signal Sv and the output signal So at the matching determination step S5. Thus, the control unit 11 can detect error in advance without simultaneously performing error detection and error portion identification, and therefore, can promptly detect error.

Moreover, according to the present embodiment, the optimal parameter having influence on error of the real machine 5 can be selected using the Mahalanobis distance D calculated at the error detection step S2, by performing the item diagnosis step S3a. Further, the Bayesian network is used at the real machine error estimation step S3b so that the error portion of the real machine 5 can be accurately estimated from the selected parameter.

Note that in the present embodiment, when it is detected that no error is caused at the real machine 5 in the error detection step S2, the control unit 11 repeatedly executes the error detection step S2 until detection of occurrence of error. However, it is not limited to such a configuration, and the error diagnosis system 1 of the present embodiment may be configured as follows.

Specifically, when it is detected that no error is caused at the real machine 5 in the error detection step S2, the control unit 11 executes the item diagnosis step S3a to select the parameter having influence on the Mahalanobis distance D, and then, executes the parameter storage step of storing the parameter selected at the item diagnosis step S3a in the storage unit 12. More specifically, the unit space F is divided into a normal unit space and a unit space where no error is caused, but caution is needed. Then, when the Mahalanobis distance D is on the inside of the unit space where no error is caused but caution is needed at the error detection step S2, the control unit 11 stores the parameter having influence on such a Mahalanobis distance D in the storage unit 12. Then, when it is detected that error is caused at the real machine 5 in the repeatedly-executed error detection step S2, the control unit 11 performs the real machine error estimation step S3b based on the parameter stored at the parameter storage step. Note that when the error analyzing step S4 and the matching determination step S5 using the parameter stored at the parameter storage step is executed and it is determined as not matched, the control unit 11 may perform the item diagnosis step S3a.

According to such a configuration, even when it is determined that no error is caused at the real machine 5, the item diagnosis step S3a is performed using the Mahalanobis distance D calculated at the error detection step S2, and in this manner, the parameter being likely to have influence on error of the real machine 5 can be selected in advance, and can be stored in the storage unit 12. Subsequently, when it is determined that error is caused at the real machine 5, the parameter selected in advance is used preferentially so that the item diagnosis step S3a can be skipped, and therefore, the real machine error estimation step S3b can be promptly performed.

Moreover, in the present embodiment, the Mahalanobis Taguchi method is used as a multidimensional statistical technique, but the present invention is not limited to such a technique. Other multidimensional statistical techniques, such as a support vector machine (SVM), may be applied.

### REFERENCE SIGNS LIST

1 ERROR DIAGNOSIS SYSTEM

5 REAL MACHINE

11 CONTROL UNIT

12 STORAGE UNIT

Si INPUT SIGNAL

So OUTPUT SIGNAL

Sv OUTPUT ANALYTICAL SIGNAL

F UNIT SPACE

D MAHALANOBIS DISTANCE

M ERROR ANALYZING MODEL

1. An error diagnosis method comprising:
a parameter value obtaining step of obtaining parameter values of multiple parameters contained in at least one of an input signal to be input to a target machine targeted for error diagnosis or an output signal output from the target machine;
an error detection step of detecting, using a multidimensional statistical technique, whether or not error is caused at the target machine based on the parameter values obtained at the parameter value obtaining step; and
an error portion estimation step of estimating an error portion of the target machine based on characteristic data obtained at the error detection step,
the multidimensional statistical technique is a Mahalanobis Taguchi method,
at the error detection step, a Mahalanobis distance from a preset unit space is calculated using the Mahalanobis Taguchi method, and it is detected whether or not the error is caused at the target machine based on the calculated Mahalanobis distance, and
at the error portion estimation step, the error portion of the target machine is estimated based on the Mahalanobis distance as the characteristic data,
the error portion estimation step includes
an item diagnosis step of selecting, using the Mahalanobis Taguchi method, the parameters having influence on the Mahalanobis distance calculated at the error detection step, and
a machine error estimation step of estimating, using a Bayesian network, the error portion of the target machine based on the parameters selected at the item diagnosis step,
at the error portion estimation step, the item diagnosis step is performed when it is determined that no error is caused at the target machine in the error detection step, and
the error portion estimation step further includes a parameter storage step of storing the parameters selected at the item diagnosis step,
in the error portion estimation step, the machine error estimation step is performed based on the parameters stored at the parameter storage step when it is determined that the error is caused at the target machine in the error detection step.

2. The error diagnosis method according to claim 1, further comprising:
a matching determination step of structuring an error analyzing model for analyzing the target machine based on the error portion of the target machine estimated at the error portion estimation step, thereby determining whether or not an output analytical signal of the target machine obtained by analysis of the error analyzing model and the output signal output from the target machine match with each other.

3-6. (canceled)

7. An error diagnosis system comprising a control unit and a storage unit, wherein in the control unit,
parameter values of multiple parameters contained in at least one of an input signal to be input to a target machine targeted for error diagnosis or an output signal output from the target machine are obtained,
based on the obtained parameter values, a Mahalanobis distance from a preset unit space is calculated using Mahalanobis Taguchi method, and it is detected whether or not the error is caused at the target machine based on the calculated Mahalanobis distance,
the parameters having influence on the Mahalanobis distance is selected, the Mahalanobis distance is characteristic data obtained by the Mahalanobis Taguchi method,
an error portion of the target machine is estimated based on the selected parameters by using a Bayesian network,
the selected parameters are stored in the storage unit when it is determined that no error is caused at the target machine, and
the error portion of the target machine is estimated based on the parameters stored in the storage unit by using a Bayesian network, when it is determined that the error is caused at the target machine.

8. The error diagnosis system according to claim 7, wherein in the control unit,
an error analyzing model for analyzing the target machine is structured based on the estimated error portion of the target machine, and it is determined whether or not an output analytical signal of the target machine obtained by analysis of the error analyzing model and the output signal output from the target machine match with each other.

9. (canceled)
